(19) United States
(12) Patent Application Publication
(10) Pub. No.: US 2026/0193050 A1
(43) Pub. Date: Jul. 9, 2026

(54) PUNCHING DEVICE AND SHEET POST-PROCESSING APPARATUS

(71) Applicant: KYOCERA Document Solutions Inc., Osaka (JP)

(72) Inventor: Rina OKADA, Osaka (JP)

(73) Assignee: KYOCERA Document Solutions Inc., Osaka (JP)

(21) Appl. No.: 19/439,104

(22) Filed: Jan. 2, 2026

(30) Foreign Application Priority Data
Jan. 8, 2025 (JP) 2025-002737

(51) Int. Cl. B65H 31/30; B26D 5/16; B65H 31/02

(52) U.S. Cl. CPC B65H 31/3081; B26D 5/16; B65H 31/02; B65H 2220/02; B65H 2301/422615

(57) ABSTRACT

A punching device includes a punching member, a pin that protrudes one end portion and the other end portion thereof in the second direction from the punching member, a holder that is coupled to the one end portion and the other end portion, and a guide that accommodates the punching member. The guide has pin insertion holes. The one end portion and the other end portion protrude to outside the guide through the pin insertion holes. The holder has a fitting hole, and the guide is fitted into the fitting hole such that the holder is held so as to be movable along an outer circumferential surface of the guide. The fitting hole has a recessed portion that is recessed outward in a radial direction. The guide has a protruding portion that is positioned within the recessed portion.

### INCORPORATION BY REFERENCE

This application is based on and claims the benefit of priority from Japanese Patent Application No. 2025-002737 filed on Jan. 8, 2025, the contents of which are hereby incorporated by reference.

### BACKGROUND

The present disclosure relates to a punching device and a sheet post-processing apparatus.

Conventionally, a punching device that performs punching on a sheet is known. The conventional punching device is installed in a sheet post-processing apparatus of an image forming apparatus.

The punching device includes a punching member that has a punching blade. The punching member is movable in an up-and-down direction. The punching device punches a hole in a sheet by moving the punching member.

### SUMMARY

According to a first aspect of the present disclosure, a punching device includes a punching member, a pin, a holder, and a guide. The punching member has a punching blade at a leading end thereof in a first direction and punches a hole in a sheet by moving in the first direction.

The pin penetrates the punching member in a second direction orthogonal to the first direction such that one end portion and the other end portion of the pin in the second direction protrude from the punching member. The holder is coupled to the one end portion and the other end portion and moves in the first direction together with the punching member by being pressed in the first direction. The guide has a cylindrical shape with an axial direction extending in the first direction, accommodates the punching member, and supports movement of the punching member in the first direction. The guide has pin insertion holes that penetrate the guide in the second direction and that are elongated in the first direction, the pin insertion holes being formed one on each of opposite sides of the guide in the second direction. The one end portion and the other end portion each protrude to outside the guide through one of the pin insertion holes that is positioned on the same side in the second direction. The holder has a fitting hole that is circular and penetrates the holder in the first direction, and the guide is fitted into the fitting hole such that the holder is held so as to be movable in the first direction along an outer circumferential surface of the guide. The fitting hole has a recessed portion that is recessed outward in a radial direction. The guide has a protruding portion that protrudes outward in the radial direction and is positioned within the recessed portion.

According to a second aspect of the present disclosure, a sheet post-processing apparatus includes the punching device and performs punching as post-processing on a printed sheet conveyed thereto from an image forming apparatus.

### BRIEF DESCRIPTION OF THE DRAWINGS

FIG. 1 is an exterior view showing a sheet post-processing apparatus according to one embodiment and an image forming apparatus coupled to it.

FIG. 2 is a schematic view showing an inner configuration of the sheet post-processing apparatus according to the embodiment.

FIG. 3 is a perspective view of a punching unit of the sheet post-processing apparatus according to the embodiment.

FIG. 4 is a perspective view of a <<punching section>> of the sheet post-processing apparatus according to the embodiment and an eccentric cam that drives it.

FIG. 5 is a perspective view of the punching section of the sheet post-processing apparatus according to the embodiment.

FIG. 6 is a plan view of the punching section of the sheet post-processing apparatus according to the embodiment as seen from a first direction.

FIG. 7 is a schematic sectional view (sectional view of the punching section taken along a plane orthogonal to a second direction) showing a state of the punching section before punching processing is performed in the sheet post-processing apparatus according to the embodiment.

FIG. 8 is a schematic sectional view (sectional view of the punching section taken along a plane orthogonal to a third direction) showing a state of the punching section before punching processing is performed in the sheet post-processing apparatus according to the embodiment.

FIG. 9 is a schematic sectional view (sectional view of the punching section taken along the plane orthogonal to the second direction) showing a state of the punching section when punching processing has been performed in the sheet post-processing apparatus according to the embodiment.

FIG. 10 is a schematic sectional view (sectional view of the punching section taken along the plane orthogonal to the third direction) showing a state of the punching section when punching processing has been performed in the sheet post-processing apparatus according to the embodiment.

FIG. 11 is a diagram (plan view of a fitting hole as seen from the first direction) showing a positional relationship between a protruding portion and a recessed portion of the sheet post-processing apparatus according to the embodiment.

FIG. 12 is a diagram (sectional view of a guide taken along a plane orthogonal to the second direction) showing a positional relationship between a pin and a pin insertion hole of the sheet post-processing apparatus according to the embodiment.

### DETAILED DESCRIPTION

### Outline of Sheet Post-Processing Apparatus

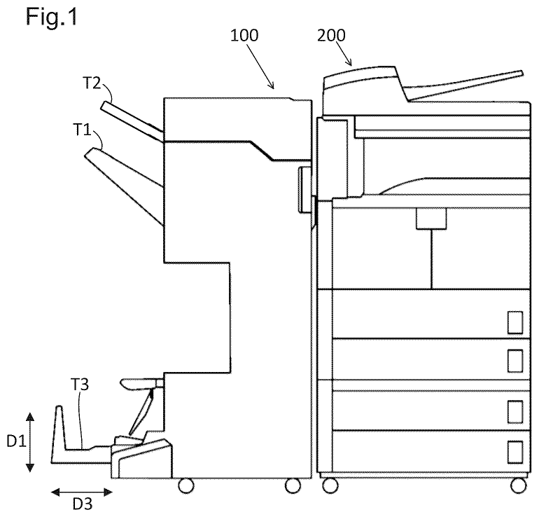

As shown in FIG. 1, a sheet post-processing apparatus 100 of the present embodiment is coupled to an image forming apparatus 200. For example, the sheet post-processing apparatus 100 is an optional apparatus, and is attachable and detachable to and from the image forming apparatus 200. The sheet post-processing apparatus 100 is disposed outside the image forming apparatus 200. Note that this is not meant as a limitation. The sheet post-processing apparatus 100 may be installed within the image forming apparatus 200.

The image forming apparatus 200 is a multifunction peripheral having a plurality of functions including a copying function. Note that the image forming apparatus 200 may be a printer. The image forming apparatus 200 conveys a sheet and prints an image on the sheet while it is being conveyed. Then, the image forming apparatus 200 feeds the printed sheet to the sheet post-processing apparatus 100. The sheet is not limited to any particular kind or type, and it may be a sheet of paper.

The image forming apparatus 200 includes a printing section (not shown). The printing section prints an image on a sheet. The printing section may employ an inkjet printing method, or may employ an electrophotographic printing method.

In a case where the printing section employs the inkjet printing method, the printing section at least includes an ink head. The printing section uses ink to print an image on a sheet. Specifically, the printing section ejects ink toward a sheet such that the ink adheres onto the sheet.

In a case where the printing section employs the electrophotographic printing method, the printing section includes components such as a photosensitive drum, a charging device, a developing device, an exposure device, a transfer roller, and the like. The printing section uses toner to print an image on a sheet. Specifically, the printing section forms an electrostatic latent image, develops the electrostatic latent image into a toner image, and transfers the thereby-obtained toner image onto the sheet.

The sheet post-processing apparatus 100 receives a sheet from the image forming apparatus 200. The sheet post-processing apparatus 100 conveys the sheet and performs on it post-processing including steps of punching processing, folding processing, stapling processing, booklet processing, etc. These steps of post-processing mentioned above are merely examples and do not all need to be implemented. Further, steps of post-processing other than those mentioned above may also be implemented.

Note that the sheet post-processing apparatus 100 may be usable independently. In that case, the sheet post-processing apparatus 100 is provided with a set tray for setting sheets thereon. The sheet post-processing apparatus 100 conveys into itself the sheet set on the set tray, and performs post-processing with respect to the sheet.

### Configuration of Sheet Post-Processing Apparatus

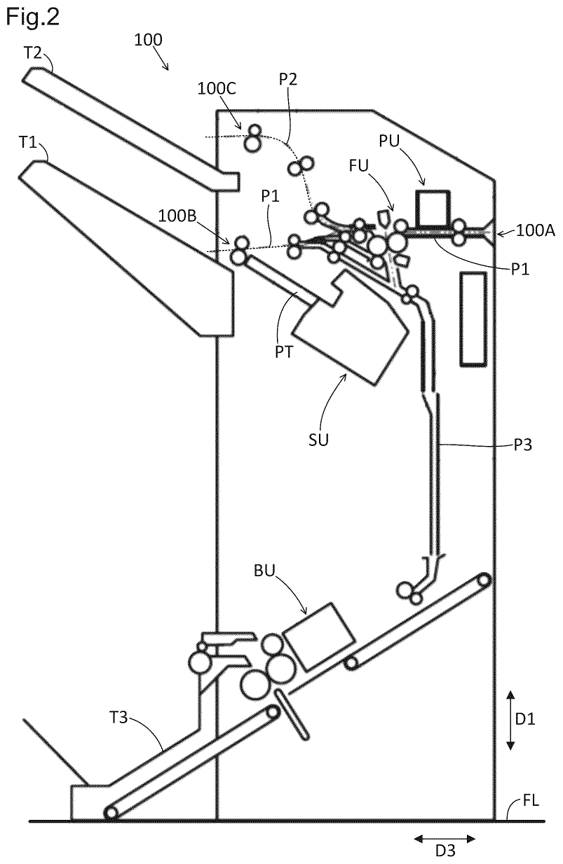

As shown in FIG. 2, the sheet post-processing apparatus 100 is installed on a floor surface FL that is substantially flat. A perpendicular direction with respect to the floor surface FL (i.e., a vertical direction) is an up-down direction of the sheet post-processing apparatus 100. The up-down direction of the sheet post-processing apparatus 100 corresponds to a “first direction.” In the following description, the up-down direction of the sheet post-processing apparatus 100 is denoted by a symbol D1, and the direction is referred to simply as the first direction D1. Note that, in the following description, upward refers to a direction toward one side in the first direction D1, and downward refers to a direction toward the other side in the first direction D1.

Further, a direction perpendicular to the sheet plane of FIG. 2 (i.e., one direction that is horizontally orthogonal to the first direction D1) is a front-rear direction of the sheet post-processing apparatus 100. The front-rear direction of the sheet post-processing apparatus 100 corresponds to a “second direction.” In the following description, the front-rear direction of the sheet post-processing apparatus 100 is denoted by a symbol D2, and the direction is referred to simply as the first second direction D2.

A direction that is orthogonal to both the first direction D1 and the second direction D2 is a left-right direction of the sheet post-processing apparatus 100. In the following description, the left-right direction of the sheet post-processing apparatus 100 is denoted by a symbol D3, and the direction is referred to simply as the third direction D3.

The sheet post-processing apparatus 100 includes a sheet inlet 100A, a main sheet outlet 100B, and a sub sheet outlet 100C. The sheet post-processing apparatus 100 further includes a main tray T1 and a sub tray T2.

The sheet inlet 100A is located on a side of the sheet post-processing apparatus 100 on which the sheet post-processing apparatus is coupled to the image forming apparatus 200. Via the sheet inlet 100A, a sheet is fed from the image forming apparatus 200 into the sheet post-processing apparatus 100. The main sheet outlet 100B and the sub sheet outlet 100C are located on a side of the sheet post-processing apparatus 100 that is opposite to the side on which the sheet post-processing apparatus 100 is coupled to the image forming apparatus 200. Via either the main sheet outlet 100B or the sub sheet outlet 100C, the sheet is discharged from the sheet post-processing apparatus 100.

The main tray T1 and the sub tray T2 are located on the side of the sheet post-processing apparatus 100 that is opposite to the side on which the sheet post-processing apparatus 100 is coupled to the image forming apparatus 200. Above the main tray T1, the sub tray T2 is disposed.

The sheet post-processing apparatus 100 discharges the sheet onto the main tray T1 or the sub tray T2. A sheet discharged from the main sheet outlet 100B is stacked on the main tray T1, and a sheet discharged from the sub sheet outlet 100C is stacked on the sub tray T2.

In the sheet post-processing apparatus 100, a first conveyance path P1 and a second conveyance path P2 are arranged. The first conveyance path P1 and the second conveyance path P2 are each a sheet conveyance path. The first conveyance path P1 extends substantially horizontally from the sheet inlet 100A and leads to the main sheet outlet 100B. The second conveyance path P2 branches diagonally upward to the left from the first conveyance path P1 and leads to the sub sheet outlet 100C.

The sheet post-processing apparatus 100 conveys a sheet from the sheet inlet 100A toward the main tray T1 or the sub tray T2. That is, a direction from right toward left within the sheet post-processing apparatus 100 is a sheet conveyance direction.

The sheet post-processing apparatus 100 includes a punch unit PU, a folding unit FU, a stapling unit SU, and a booklet unit BU. The punch unit PU, the folding unit FU, the stapling unit SU, and the booklet unit BU each perform a corresponding step of post-processing on a sheet.

The punch unit PU is disposed on the first conveyance path P1 so as to be positioned on an upstream side in the sheet conveyance direction. The punch unit PU performs, as post-processing, punching processing to punch a hole in a sheet. Thus, the punch unit PU corresponds to a “punching device.” Through the performance of punching processing, a punch hole is formed in a sheet. Note that the punching device as the punch unit PU may be usable independently. In that case, a sheet may be set manually for punching processing to be performed with respect to the sheet.

The folding unit FU is disposed downstream of the punch unit PU in the sheet conveyance direction. The folding unit FU performs, as post-processing, folding processing to fold a sheet. For example, through folding processing, a sheet can be Z-folded.

The stapling unit SU performs, as post-processing, stapling processing to bind a bundle of a plurality of sheets with a staple. During staple processing, a plurality of sheets are stacked on a processing tray PT. The stapling unit SU performs stapling processing with respect to the plurality of sheets stacked on the processing tray PT.

The booklet unit BU performs, as post-processing, booklet processing to fold a center-stapled bundle of sheets in the center. The booklet unit BU includes a stapling section for center-stapling, and uses the stapling section to bind a bundle of sheets in the center with a staple.

For example, the sheet post-processing apparatus 100 includes a third conveyance path P3 that branches off from the first conveyance path P1 to extend downward. The third conveyance path P3 leads to the booklet unit BU. In a case where booklet processing is performed, sheets are conveyed via the third conveyance path P3 to the booklet unit BU.

The sheet post-processing apparatus 100 further includes a booklet tray T3. The booklet tray T3 is provided on the side of the sheet post-processing apparatus 100 that is opposite to the side on which the sheet post-processing apparatus 100 is coupled to the image forming apparatus 200. The booklet tray T3 is disposed below the main tray T1. Onto the booklet tray T3, a booklet obtained through booklet processing is discharged.

### Configuration of Punch Unit

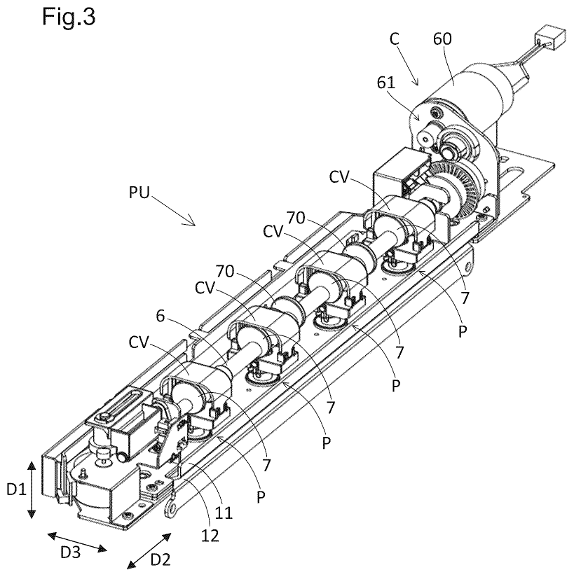

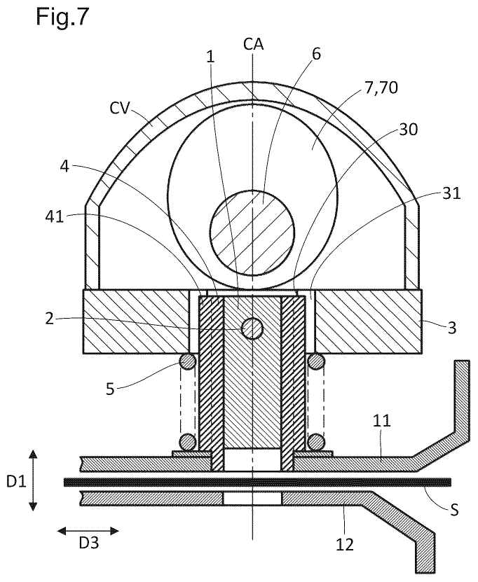

The punch unit PU has a configuration as shown in FIGS. 3 to 12. In FIGS. 7 to 10, a sheet as a target of punching processing is denoted by a symbol S.

The punch unit PU includes an upper guide portion 11 and a lower guide portion 12. The upper guide portion 11 and the lower guide portion 12 are arranged to face each other in the first direction D1 so as to be spaced from each other. At the position at which the punch unit PU is installed in the first conveyance path P1, a region between the upper guide portion 11 and the lower guide portion 12 in the first direction D1 functions as the first conveyance path P1. In the first conveyance path P1, through the region between the upper guide portion 11 and the lower guide portion 12 in the first direction D1, a sheet S is conveyed in the third direction D3.

The punch unit PU includes a punching section P. The punching section P punches a hole in such part of a sheet S that is located between the upper guide portion 11 and the lower guide portion 12 in the first direction D1. There is no particular limitation on the quantity of the punching section P to be provided. For example, as the punching section P, a plurality of punching sections P are provided. The plurality of punching sections P are arranged so as to be spaced from each other in the first direction D1. Here, the number of the punching sections P is four.

The punch unit PU further includes a cam mechanism C. The cam mechanism C drives the punching sections P. The punching sections P are each driven to punch a hole in a sheet S.

Hereinafter, a description will be given of configurations of the punching sections P, with a focus on one of the punching sections P. The punching sections P are identical to each other in configuration. Thus, descriptions of the configurations of the other punching sections P will be omitted, with reference to the following description.

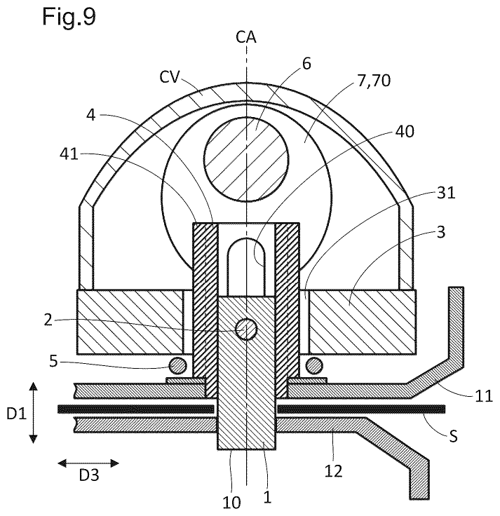

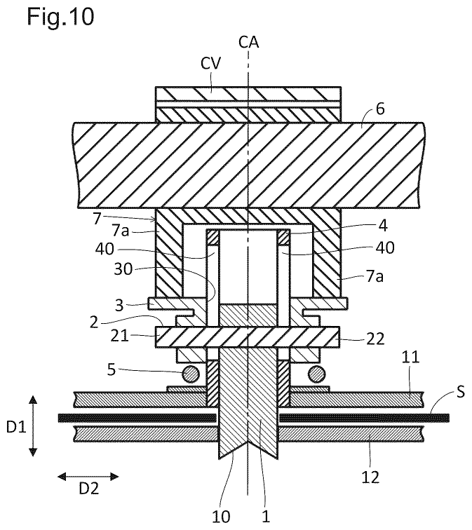

The punching section P includes a punching member 1. The punching member 1 is a cylindrical component made of metal. The punching member 1 has a cylindrical shape with an axial direction extending in the first direction D1. The punching member 1 has a punching blade 10 at a leading end thereof in the first direction D1. The punching blade 10 is provided at a lower end portion of the cylindrical component constituting the punching member 1. The punching member 1 moves in the first direction D1 to thereby punch a hole in such part of a sheet S that is located between the upper guide portion 11 and the lower guide portion 12 in the first direction D1 (see FIG. 9 and FIG. 10).

In this configuration, the upper guide portion 11 and the lower guide portion 12 are provided with openings (of which symbols are omitted) penetrating them in the first direction D1. The punching member 1 moves through the openings in the first direction D1. The punching member 1 moves in the first direction D1 to thereby cause the punching blade 10 to move from above the upper guide portion 11, via the openings, to reach a position below the lower guide portion 12. In this manner, a hole is punched in such part of a sheet S that is located between the upper guide portion 11 and the lower guide portion 12 in the first direction D1.

Herein, a cylinder axis (that is, a central axis) of the cylindrical component serving as the punching member 1 extending in the first direction D1 is defined as a central axis of the punching section P. The central axis of the punching section P is denoted by a symbol CA, and the central axis will be referred to simply as the central axis CA. A circumferential direction of a circle about the central axis CA is referred to simply as the circumferential direction, and a radial direction of the circle about the central axis CA is simply referred to as the radial direction. Note that a direction that is outward in the radial direction is a direction separating from the central axis CA, and a direction that is inward in the radial direction is a direction approaching the central axis CA.

The punching section P includes a pin 2. The pin 2 is a round bar made of metal. The pin 2 extends in the second direction D2. In the following description, one of opposite end portions of the pin 2 in the second direction D2 is denoted by a symbol 21 and is referred to as the one end portion 21, and the other one of the opposite end portions is denoted by a symbol 22 and is referred as the other end portion 22.

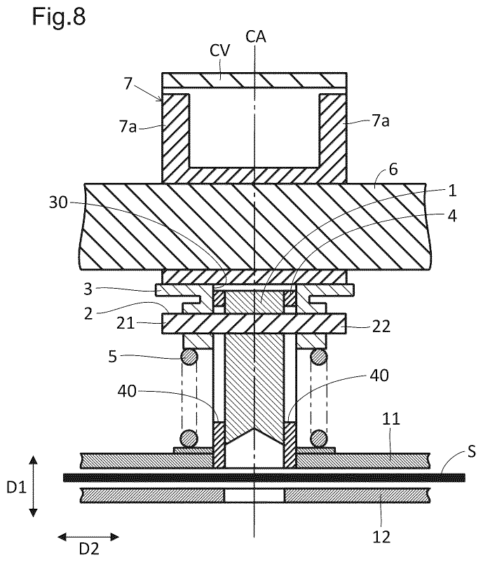

The pin 2 is attached to the punching member 1. Specifically, at an upper end portion of the punching member 1, a through hole (a symbol of which is omitted) is formed that penetrates the punching member 1 in the second direction D2. The pin 2 is inserted into the through hole of the punching member 1 to be thereby attached to the punching member 1. The pin 2 penetrates the upper end portion of the punching member 1 in the second direction D2. As a result, the one end portion 21 protrudes from the punching member 1 to one side in the second direction D2, and the other end portion 22 protrudes from the punching member 1 to the other side in the second direction D2 (see FIG. 8 and FIG. 10).

The punching section P includes a holder 3. The holder 3 is a resin-molded component.

The holder 3, as seen from the first direction D1, has a substantially rectangular external shape with a short-side direction thereof extending in the second direction D2 and a long-side direction thereof extending in the third direction D3.

The holder 3 includes a fitting hole 30. The fitting hole 30 penetrates the holder 3 in the first direction D1. The fitting hole 30 has an opening shape that is substantially circular as seen from the first direction D1. Specifically, the opening shape of the fitting hole 30 is, as seen from the first direction D1, a circular shape partly having a recess (a recessed portion 31 described later). The fitting hole 30 has a center that coincides with the central axis CA as seen from the first direction D1.

The holder 3 is coupled to the one end portion 21 and the other end portion 22. In other words, the holder 3 is coupled via the pin 2 to the punching member 1. This arrangement allows the holder 3 to move together with the punching member 1 in the first direction D1.

The punching section P includes a guide 4. The guide 4 is made of metal. For example, the guide 4 is a sintered component formed of metal powder. The guide 4 has a cylindrical shape with an axial direction thereof extending in the first direction D1. The guide 4 is attached to the upper guide portion 11. The guide 4 protrudes upward from an upper surface of the upper guide portion 11. The guide 4 is disposed at the opening (movement path for the punching member 1) of the upper guide portion 11. That is, the guide 4 has a cylinder axis that coincides with the central axis CA as seen from the first direction D1.

The guide 4 accommodates the punching member 1. The punching member 1 is disposed within the cylindrical component functioning as the guide 4. In a state of being disposed within the guide 4, the punching member 1 has an outer circumferential surface thereof in contact with an inner circumferential surface of the guide 4. The punching member 1 is slidable in the first direction D1 with respect to the inner circumferential surface of the guide 4. In this manner, movement of the punching member 1 in the first direction D1 is supported by the guide 4.

The guide 4 includes a pair of pin insertion holes 40. The pair of pin insertion holes 40 are formed in a body portion of the cylindrical component functioning as the guide 4. The pair of pin insertion holes 40 are respectively disposed on one and the other side of the guide 4 in the second direction D2.

The pin insertion holes 40 are each a hole elongated in the first direction D1. The pin insertion holes 40 each penetrate the body portion of the guide 4 in the second direction D2. With the punching member 1 disposed within the guide 4, the one end portion 21 of the pin 2 protrudes to outside the guide 4 through one of the pin insertion holes 40 on the one side in the second direction D2 (that is, the pin insertion hole 40 on the same side as the one end portion 21), and the other end portion 22 of the pin 2 protrudes to outside the guide 4 through the other one of the pin insertion holes 40 on the other side in the second direction D2 (that is, the pin insertion hole 40 on the same side as the other end portion 22). With this arrangement, even with the configuration where the punching member 1 is disposed within the guide 4, the punching member 1 and the holder 3 can be coupled via the pin 2.

The punching section P further includes a compression coil spring 5. The compression coil spring 5 is disposed outside of the guide 4 in the radial direction. The compression coil spring 5 is disposed between the upper guide portion 11 and the holder 3 in the first direction D1. With this arrangement, the compression coil spring 5 upwardly biases the holder 3.

Hereinafter, a description will be given of a configuration of the cam mechanism C. The cam mechanism C is a movement mechanism that causes each punching member 1 to reciprocate in the first direction D1. Note that the cam mechanism C described below is merely an example, and is not meant to particularly limit the configuration of the cam mechanism C. A mechanism other than the cam mechanism C may be used to cause the punching member 1 to reciprocate in the first direction D1.

The cam mechanism C includes a shaft 6. The shaft 6 is a round bar extending in the second direction D2. The shaft 6 is rotatable about an axis extending in the second direction D2. The shaft 6 is disposed above the punching sections P, spanning the punching sections P in the second direction D2. With this arrangement, the shaft 6 is disposed so as to be above each punching member 1 (that is, above each guide 4).

The cam mechanism C includes a punching motor 60. The punching motor 60 is connected to the shaft 6 via a drive transmission mechanism 61 including a gear and the like. The shaft 6 rotates by being driven by the punching motor 60.

The cam mechanism C includes an eccentric cam 7. The eccentric cam 7 is attached to the shaft 6. The shaft 6 (that is, the shaft extending in the second direction D2) functions as a rotation shaft of the eccentric cam 7. The eccentric cam 7 is caused by the rotation of the shaft 6 to rotate together with the shaft 6.

As the eccentric cam 7, a plurality of eccentric cams 7 are provided and assigned one-to-one to the punching sections P. That is, as the eccentric cam 7, four eccentric cams 7 are provided. The eccentric cams 7 each contact an upper surface of the holder 3 of the corresponding one of the punching sections P. The eccentric cams 7 each rotate about the shaft 6, thereby pressing the holder 3 of the corresponding one of the punching sections P downward from above. By being pressed downward from above, the holder 3 of each of the punching sections P moves in the first direction DI together with the punching member 1 coupled thereto.

The eccentric cams 7 are each covered by a corresponding one of cam covers CV from above. Each of the cam covers CV is attached to the holder 3 of a corresponding one of punching sections P.

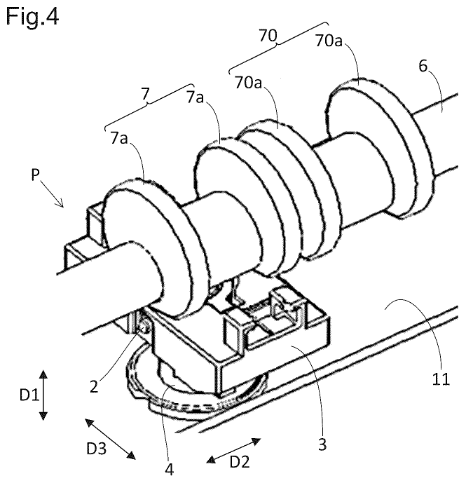

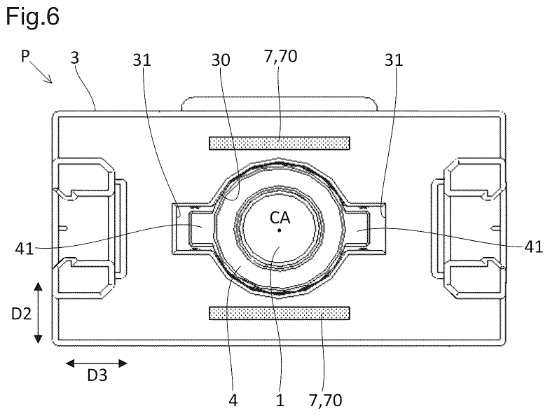

The eccentric cams 7 each have two cam portions 7a (see FIG. 4). The two cam portions 7a of each of the eccentric cams 7 are arranged so as to be spaced from each other in the second direction D2. The two cam portions 7a of each of the eccentric cams 7 are arranged, as seen from the first direction D1, so as to face each other in the second direction D2 with the fitting hole 30 of a corresponding one of the punching sections P therebetween (see FIG. 6). In FIG. 6, the eccentric cam 7 is illustrated with a dotted pattern.

Note that the cam mechanism C further includes a two-hole eccentric cam 70. The two-hole eccentric cam 70, similarly to the eccentric cam 7, includes two cam portions 70a arranged so as to be spaced from each other in the second direction D2. The two-hole eccentric cam 70 is attached to the shaft 6, and rotates together with the shaft 6. Further, as the two-hole eccentric cam 70, two two-hole eccentric cams 70 are provided and assigned one-to-one to the two punching sections P located centrally in the second direction D2 among the four punching sections P.

The shaft 6 is movable in the second direction D2. The shaft 6 moves in the second direction D2 to thereby shift between a first position and a second position. The first position is the position of the shaft 6 as shown in FIG. 3 and FIG. 4. When the shaft 6 is located at the first position, the holder 3 of each of the four punching sections P is pressed from above by the eccentric cam 7. On the other hand, although not shown, when the shaft 6 is located at the second position, only the two punching sections P located centrally in the second direction D2 among the four punching sections P each have the holder 3 thereof pressed from above by a corresponding one of the two-hole eccentric cams 70.

With the shaft 6 located at the first position, when the punching motor 60 is driven, all the four punching sections P are caused to perform punching operation. Specifically, the holder 3 of each of all the four punching sections P is pressed downward from above by a corresponding one of the eccentric cams 7, and thereby the punching member 1 of each of all the four punching sections P is caused to reciprocate in the first direction D1. As a result, a punch hole is formed at each of four positions simultaneously on a single sheet S.

On the other hand, although not illustrated, when the shaft 6 is located at the second position, when the punching motor 60 is driven, only the two punching sections P located centrally in the second direction D2 perform punching operation. Specifically, the holder 3 of each of the two punching section P is pressed by the corresponding one of the two-hole eccentric cams 70 downward from above, and thereby the punching member 1 of each of the two punching sections P is caused to reciprocate in the first direction D1. As a result, a punch hole is formed at each of two positions simultaneously on a single sheet S.

FIGS. 7 and 8 show a state observed when the holder 3 is not pressed by the eccentric cam 7 (or the two-hole eccentric cam 70). In this state, the punching blade 10 does not reach a sheet S.

On the other hand, FIGS. 9 and 10 show a state observed after the shaft 6 in the state shown in FIGS. 7 and 8 has rotated about the axis extending in the second direction D2. Specifically, the holder 3 is pressed downward from above by the eccentric cam 7 (or the two-hole eccentric cam 70). As a result, the holder 3 shifts downward against biasing force of the compression coil spring 5. The punching member 1 shifts downward together with the holder 3. At this time, the pin 2 moves within the pin insertion holes 40 in the first direction D1.

The holder 3 is pressed downward from above by the eccentric cam 7 (or the two-hole eccentric cam 70) to thereby cause the punching member 1 to penetrate a sheet S in the first direction D1. In short, the punching blade 10 punches a hole in the sheet S. In this manner, a punch hole is formed in the sheet S.

### Rotation Stopper for Punching Member

In the state of being disposed within the guide 4, the punching member 1 is slidable in the circumferential direction with respect to the inner circumferential surface of the guide 4. If the punching member 1 shifts greatly in the circumferential direction, the pin will come into contact with inner circumferential surfaces of the pin insertion holes 40. Here, the pin 2 and the guide 4 are respectively made of metal. Thus, if the punching member 1 moves in the first direction D1 with the pin 2 in contact with the inner circumferential surfaces of the pin insertion holes 40, a loud noise may be generated.

This inconvenience can be prevented by preventing the punching member 1 from shifting in the circumferential direction, that is, by preventing the holder 3 from shifting in the circumferential direction. For this purpose, the punching section P is equipped with measures to prevent the holder 3 from shifting in the circumferential direction.

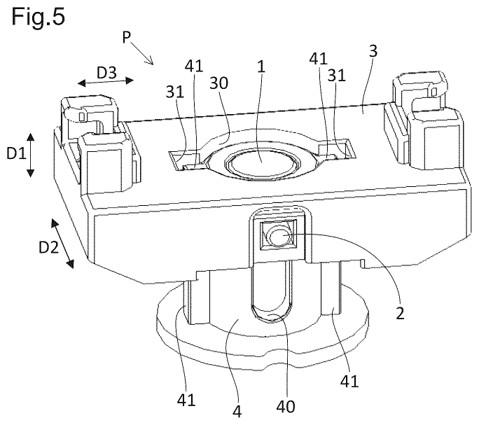

Specifically, as shown in FIGS. 5 and 6, the holder 3 includes a rotation stopper that is formed in the fitting hole 30. The fitting hole 30 has a recessed portion 31 that is recessed in a rectangular shape outward in the radial direction from an inner circumferential surface thereof as seen from the first direction D1. The recessed portion 31 has a pair of inner side surfaces facing each other with a space therebetween in the second direction D2 as seen from the first direction D1.

For example, as the recessed portion, two recessed portions 31 are formed. As seen from the first direction D1, one of the two recessed portions 31 is recessed in the rectangular shape outward in the radial direction from one side of the fitting hole 30 in the third direction D3. As seen from the first direction D1, the other one of the two recessed portions 31 is recessed in the rectangular shape outward in the radial direction from the other side of the fitting hole 30 in the third direction D3.

Further, the guide 4 has a protruding portion 41 that functions as a rotation stopper.

The protruding portion 41 protrudes in a rectangular shape from an outer circumferential surface of the guide 4 as seen from the first direction D1. The guide 4 has the same number of (that is, two) protruding portions 41 as the recessed portions 31. The protruding portions 41 are assigned one-to-one to the two recessed portions 31. The two protruding portions 41 are each located within the corresponding one of the recessed portions 31. That is, the two protruding portions 41 are each located between a pair of inner side surfaces of the corresponding one of the recessed portions 31, the pair of inner side surfaces facing each other in the second direction D2.

In the present embodiment, by coupling the punching member 1 and the holder 3 to each other by means of the pin 2, it is made possible to move the punching member 1 in the first direction D1 without protruding the punching member 1 upward from the guide 4. In a conventional configuration (not shown), a punching member is disposed to protrude upward from a guide and an upper end portion of the punching member is pressed from above by an eccentric cam. This arrangement increases the up-down dimension of the conventional configuration. In contrast, in the present embodiment, the up-down dimension of the punch unit PU can be reduced as compared to the conventional configuration by the extent to which the punching member 1 does not protrude above the guide 4.

Here, in the present embodiment, the recessed portions 31 are formed in the fitting hole 30, the protruding portions 41 are formed in the guide 4, and the protruding portions 41 are located within the recessed portions 31. With this arrangement, even if the holder 3 tends to shift in the circumferential direction, since the protruding portions 41 contact the inner side surfaces of the recessed portion 31, shift of the holder 3 in the circumferential direction is suppressed. Further shift of the holder 3 in the circumferential direction is prevented after the inner side surfaces of the recessed portions 31 make contact with the protruding portions 41.

The suppression of the shift of the holder 3 in the circumferential direction implies that the shift of the punching member 1 in the circumferential direction is suppressed and that the shift of the one end portion 21 and the other end portion 22 of the pin 2 attached to the punching member 1 in the circumferential direction is also suppressed. If the one end portion 21 and the other end portion 22 of the pin 2 do not shift greatly in the circumferential direction, the pin 2 does not come into contact with the inner circumferential surfaces of the pin insertion holes 40.

If the pin 2 does not contact the inner circumferential surfaces of the pin insertion holes 40, it is possible to suppress movement of the punching member 1 in the first direction D1 with the pin 2 in contact with the inner circumferential surfaces of the pin insertion holes 40. With this arrangement, it is possible to achieve a more compact punch unit PU while suppressing the generation of loud noise during the movement of the punching member 1 in the first direction D1 (that is, during punching with respect to a sheet S).

Note that, in the present invention, the protruding portions 41 extend in the first direction D1. Thus, the protruding portions 41 are arranged over an entire range of the moving paths of the recessed portions 31 in the first direction D1. As a result, even when the holder 3 moves in the first direction D1, the protruding portions 41 do not come off the recessed portions 31 but stay located within the recessed portions 31. In other words, wherever the holder 3 is located in the first direction D1, it is possible to suppress the shift of the holder 3 in the circumferential direction.

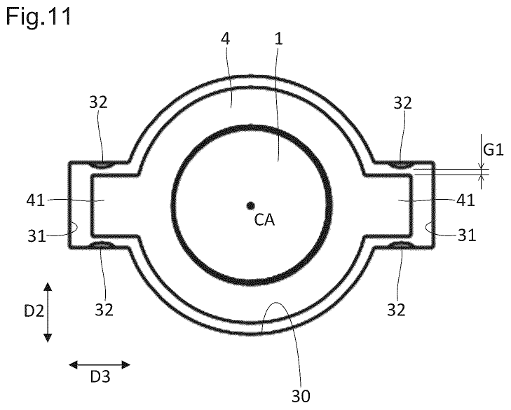

Further, in the present embodiment, in the recessed portions 31, the pair of inner side surfaces of each of the recessed portions 31, the pair of side surfaces facing each other in the second direction D1 with a corresponding one of the protruding portions 41 therebetween, each have a protrusion 32 that protrudes toward the corresponding one of the protruding portions 41 (see FIG. 11). For example, the protrusion has a tip end having a rounded shape. With this arrangement, the contact made between the recessed portions 31 and the protruding portions 41 is a point contact, and this helps suppress wear of the inner side surfaces of the recessed portions 31.

In other words, it is possible to suppress an increase in the widths of the recessed portions 31 in the second direction D2 from their initial widths.

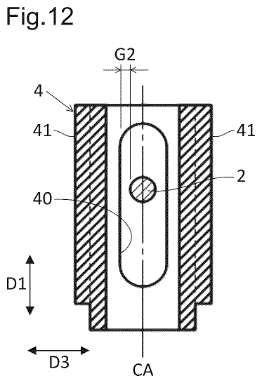

Further, in the present embodiment, a clearance G1 (see FIG. 11) between the recessed portions 31 and the protruding portions 41 is smaller than a clearance G2 (see FIG. 12) between the pin 2 and each of the pin insertion holes 40. The clearance G1 is a space (gap) in the second direction D2 between the inner side surfaces of the recessed portions 31 and outer side surfaces of the protruding portions 41. In a case where the inner side surface of each of the recessed portions 31 has the protrusion 32, the clearance G1 is the space (gap) between the protrusion 32 and the outer side surface of a corresponding one of the protruding portions 41 in the second direction D2. The clearance G2 is a space (gap) between the outer circumferential surface of the pin 2 and the inner circumferential surface of each of the pin insertion holes 40. With this configuration, even if the holder 3 (that is, the punching member 1) shifts by a maximum amount in the circumferential direction, it is possible to prevent the pin 2 from contacting the inner circumferential surfaces of the pin insertion holes 40.

The embodiment disclosed herein is merely an example in every aspect, and should not be interpreted as a limitation. The scope of the present disclosure is defined not by the above description of the embodiment but by the claims, and should be understood to include all modifications within meaning and scope equivalent to the claims.

What is claims is:

1. A punching device, comprising:
a punching member that has a punching blade at a leading end thereof in a first direction and that punches a hole in a sheet by moving in the first direction;
a pin that penetrates the punching member in a second direction orthogonal to the first direction such that one end portion and an other end portion of the pin protrude in the second direction from the punching member;
a holder that is coupled to the one end portion and the other end portion and that moves in the first direction together with the punching member by being pressed in the first direction; and
a guide that has a cylindrical shape having an axial direction extending in the first direction and that accommodates the punching member and supports movement of the punching member in the first direction,
wherein
the guide has pin insertion holes that penetrate the guide in the second direction and that are elongated in the first direction, the pin insertion holes being formed one on each of opposite sides of the guide in the second direction,
the one end portion and the other end portion each protrude to outside the guide through one of the pin insertion holes that is positioned on a same side in the second direction,
the holder has a fitting hole that is circular and penetrates the holder in the first direction, and the guide is fitted into the fitting hole such that the holder is held so as to be movable in the first direction along an outer circumferential surface of the guide,
the fitting hole has a recessed portion that is recessed outward in a radial direction, and
the guide has a protruding portion that protrudes outward in the radial direction thereof and is positioned within the recessed portion.

2. The punching device according to claim 1,
wherein
a clearance provided between the recessed portion and the protruding portion is smaller than a clearance provided between the pin and each of the pin insertion holes.

3. The punching device according to claim 1,
wherein
a pair of inner side surfaces of the recessed portion that face each other with the protruding portion therebetween each have a protrusion that protrudes toward the protruding portion.

4. A sheet post-processing apparatus, comprising the punching device according to claim 1,
wherein
the sheet post-processing apparatus performs punching processing as post-processing with respect to a printed sheet that is conveyed thereto from an image forming apparatus.
